(19) United States
(12) Patent Application Publication
(10) Pub. No.: US 2026/0141398 A1
(43) Pub. Date: May 21, 2026

(54) SYSTEM AND METHOD FOR SCORING USER TRANSACTIONS BY MONITORING CONTEXTUAL AND TEMPORAL FEATURES

(71) Applicant: KRISHNA CHAITANYA YARLAGADDA, GEORGETOWN, TX (US)

(72) Inventor: KRISHNA CHAITANYA YARLAGADDA, GEORGETOWN, TX (US)

(21) Appl. No.: 19/447,295

(22) Filed: Jan. 13, 2026

(51) Int. Cl. G06Q 20/40

(52) U.S. Cl. CPC G06Q 20/4016

(57) ABSTRACT

A system and method for method for scoring a user transaction by monitoring contextual and temporal features is disclosed. The method includes receiving, from one or more client devices, transaction data associated with a digital transaction of a user. The method includes receiving, from a plurality of data sources, a set of contextual features. The method includes extracting, from an activity history of the user, a set of temporal features. The method includes generating a personalized temporal-context representation of the user based on the received set of contextual features and the extracted set of temporal features. The method includes detecting a deviation between the personalized temporal-context representation and a baseline behavioral signature of the user. The method includes computing a transaction-risk score. The method includes generating a decision output. The method includes transmitting, to a payment gateway, one or more of the transaction-risk score of the decision output.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates digital transaction analytics. More particularly, to systems and methods for scoring user transactions by monitoring contextual and temporal features.

### BACKGROUND OF THE INVENTION

Digital payment ecosystems increasingly rely on automated decisioning engines to determine whether a transaction initiated by a user should be authorized, declined, or subjected to additional verification. Traditional fraud-detection and transaction-scoring systems predominantly evaluate static rules, population-level risk factors, or isolated transaction attributes. Such approaches often fail to capture the individualized behavioral patterns of users and do not effectively reflect the temporal dynamics associated with daily, weekly, or seasonal transaction activities.

Existing solutions typically process contextual features, such as device identifiers or merchant category codes, without correlating them with temporal signals or with user-specific behavioral histories. As a result, the existing solutions treat legitimate deviations as suspicious or overlook subtle anomalies that appear only when analyzed in relation to an established temporal behavior of a user.

Moreover, the users interact with financial platforms across devices, locations, and service channels, producing diverse data streams that are not jointly modeled in a unified behavioral representation. The absence of integrated contextual-temporal analysis limits the precision and adaptability of transaction-scoring systems. Additionally, many conventional approaches depend on static models that require periodic retraining and do not adapt in real time to emerging behavioral changes.

Therefore, there is need to develop systems and methods to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for scoring a user transaction by monitoring contextual and temporal features is disclosed. The method includes receiving, from one or more client devices, transaction data associated with a digital transaction of a user. The method includes receiving, from a plurality of data sources, a set of contextual features associated with the user transaction based on the received transaction data. Further, the method includes extracting, from an activity history of the user, a set of temporal features based on the received set of contextual features. The method includes generating a personalized temporal-context representation of the user based on the received set of contextual features and the extracted set of temporal features. The method includes detecting a deviation between the personalized temporal-context representation and a baseline behavioral signature of the user. The method includes computing a transaction-risk score indicative of one or more of an abnormal activity and a fraudulent activity. The method includes generating a decision output based on the transaction-risk score and the personalized temporal-context representation. The method includes transmitting, to a payment gateway, one or more of the transaction-risk score of the decision output for downstream authorization of the digital transaction.

In accordance with another embodiment of the present disclosure, a system for scoring a user transaction by monitoring contextual and temporal features is disclosed. The system includes a memory and at least one processor operatively coupled to the memory. The at least one processor is configured to receive, from one or more client devices, transaction data associated with a digital transaction of a user. The at least one processor is configured to receive, from a plurality of data sources, a set of contextual features associated with the user transaction based on the received transaction data. The at least one processor is configured to extract, from an activity history of the user, a set of temporal features based on the received set of contextual features. The at least one processor is configured to generate a personalized temporal-context representation of the user based on the received set of contextual features and the extracted set of temporal features. The at least one processor is configured to detect a deviation between the personalized temporal-context representation and a baseline behavioral signature of the user. The at least one processor is configured to compute a transaction-risk score indicative of one or more of an abnormal activity and a fraudulent activity. The at least one processor is configured to generate a decision output based on the transaction-risk score and the personalized temporal-context representation. The at least one processor is configured to transmit, to a payment gateway, one or more of the transaction-risk score of the decision output for downstream authorization of the digital transaction.

In accordance with another embodiment of the present disclosure, a non-transitory computer-readable medium storing instructions that, when executed, cause a processor to receive, from one or more client devices, transaction data associated with a digital transaction of a user. The processor is configured to receive, from a plurality of data sources, a set of contextual features associated with the user transaction based on the received transaction data. The processor is configured to extract, from an activity history of the user, a set of temporal features based on the received set of contextual features. The processor is configured to generate a personalized temporal-context representation of the user based on the received set of contextual features and the extracted set of temporal features. The processor is configured to detect a deviation between the personalized temporal-context representation and a baseline behavioral signature of the user. The processor is configured to compute a transaction-risk score indicative of one or more of an abnormal activity and a fraudulent activity. The processor is configured to generate a decision output based on the transaction-risk score and the personalized temporal-context representation. The processor is configured to transmit, to a payment gateway, one or more of the transaction-risk score of the decision output for downstream authorization of the digital transaction.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram depicting an exemplary environment of distributed cloud nodes associated with a system in distributed cloud environments, in accordance with an embodiment of the present disclosure;

FIG. 2 illustrates a block diagram depicting a system for updating the one or more optimization policies in the distributed cloud environments, in accordance with an embodiment of the present disclosure; and

FIG. 3A-FIG. 3B illustrates a flowchart depicting a method for updating the one or more optimization policies in the distributed cloud environments, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

An environment and various implementations of methods and systems capable of evaluating digital transactions by jointly analyzing contextual features and temporal features, generating personalized behavioral representations, and detecting deviations relative to a continuously updated behavioral baseline. Such techniques enable more accurate and responsive scoring mechanisms that reflect the evolving transactional patterns of individual users. The systems and methods for computing a transaction-risk score based on the contextual features and the temporal features associated with user behavior. The systems include behavioral modeling techniques used in fraud detection, authorization decisioning, and transaction-scoring processes in financial-technology environments.

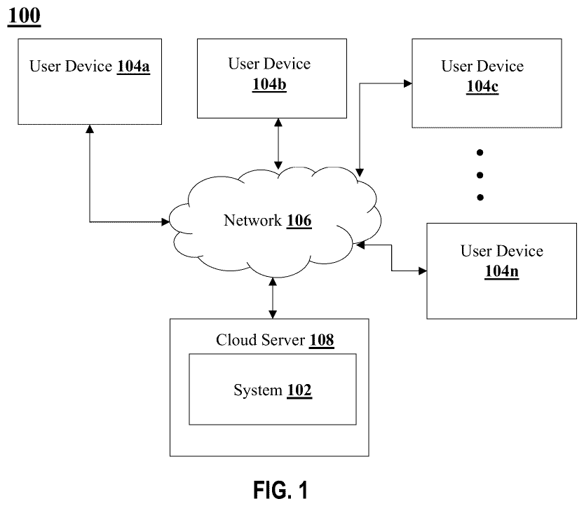

The environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates a block diagram depicting an environment 100 of a system 102 for scoring a user transaction by monitoring contextual and temporal features, in accordance with an embodiment of the present disclosure. The system 102 may be configured to receive transaction data associated with a digital transaction of a user from one or more user devices 104a, 104b . . . 104n. The one or more user devices 104a, 104b . . . 104n may refer to any computing device operated by the user for initiating or participating in a digital transaction, and configured to transmit the transaction data to the system 102.

The one or more user devices 104a, 104b . . . 104n may include, but are not limited to, a mobile phone, a smartphone, a tablet computer, a laptop computer, a desktop computer, a wearable device, a point-of-sale terminal, or an internet-connected embedded device. The transaction data may include a transaction amount, a merchant category, a device identifier, a transaction timestamp, and the like.

In an embodiment, the system 102 may be configured to receive a set of contextual features associated with the user transaction from a plurality of data sources based on the received transaction data. The set of contextual features may include, but are not limited to, one or more of device usage patterns, one or more geological consistency signals, one or more network characteristics, and one or more historical merchant interaction profiles.

In an embodiment, the system 102 may be implemented within a cloud server 108 and communicated with the one or more user devices 104a, 104b . . . 104n. The cloud server 108 may refer to one or more computing nodes deployed in a cloud computing environment. The cloud server 108 may include at least one processor, a memory storing executable instructions, and a network interface enabling communication with the one or more user devices 104a, 104b . . . 104n.

In another embodiment, the system 102 may be implemented within the one or more user devices 104a, 104b . . . 104n. Yet, in another embodiment, the system 102 may be externally connected to the one or more user devices 104a, 104b . . . 104n. Yet, in another embodiment, some part of the system 102 may be implemented within the one or more user devices 104a, 104b . . . 104n and remaining part of the system 102 may be externally connected to the one or more user devices 104a, 104b . . . 104n.

In an embodiment, the system 102 may be configured to extract a set of temporal features based on the received set of contextual features from an activity history of the user. The set of temporal features may include, but is not limited to, one or more periodic time-of-day patterns, one or more weekday-weekend deviations, one or more seasonality-based behavioral cycles, and the like. Further, the set of temporal features may include pay cycle aligned periodicity, one or more holiday-specific activity markers, and one or more long-horizon behavioural seasonality indicators.

Further, the system 102 may be configured to generate a personalized temporal-context representation of the user based on the received set of contextual features and the extracted set of temporal features. Furthermore, the system 102 may be configured to detect a deviation between the personalized temporal-context representation and a baseline behavioral signature of the user.

The baseline behavioral signature of the user may include a data structure generated from historical transaction records of the user. The data structure may include one or more aggregated contextual feature profiles derived from past transactions, one or more aggregated temporal feature profiles, and one or more statistical or machine-learned parameters updated over time to reflect the prior behavioral patterns of the user.

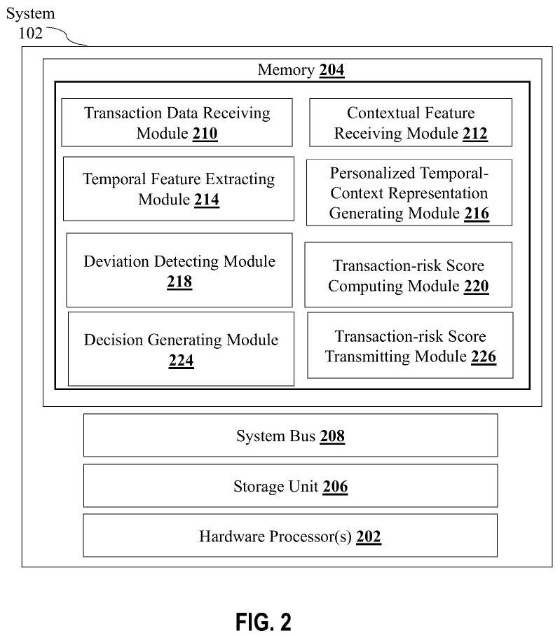

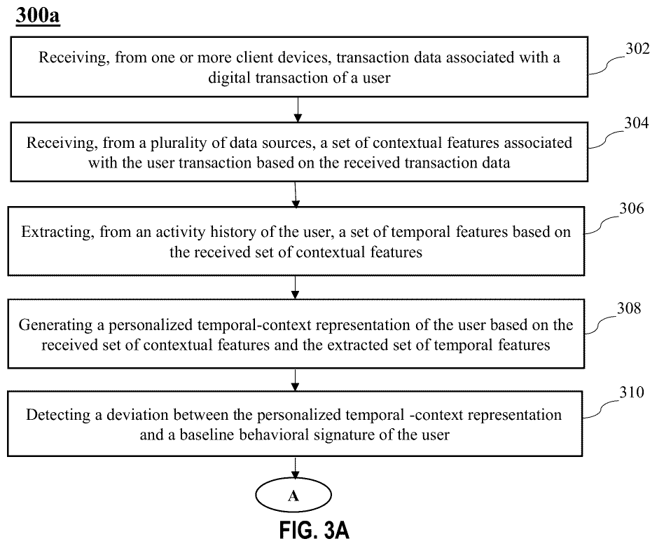

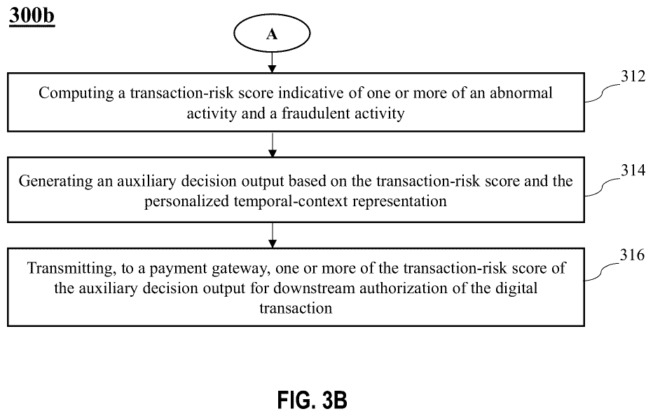

Further, the system 102 may be configured to compute a transaction-risk score indicative an abnormal activity or a fraudulent activity. Furthermore, the system 102 may be configured to generate a decision output based on the transaction-risk score and the personalized temporal-context representation. In addition, the system 102 may be configured transmit one or more of the transaction-risk score of the decision output to a payment gateway for downstream authorization of the digital transaction. The system 102 has been further detailed with reference to FIG. 2 and FIG. 3A and FIG. 3B.

FIG. 2 illustrates a block diagram depicting the system 102 for scoring the user transaction by monitoring the contextual features and the temporal features, in accordance with an embodiment of the present disclosure. According to FIG. 2, the system 102 may include one or more hardware processors 202, a memory 204 and a storage unit 206. The one or more hardware processors 202, the memory 204 and the storage unit 206 may be communicatively coupled through a system bus 208 or any similar mechanism. The memory 204 may include a transaction data receiving module 210, a contextual feature receiving module 212, a temporal feature extracting module 214, a personalized temporal-context representation generating module 216, a deviation detecting module 218, a transaction-risk score computing module 220, a decision generating module 224, and a transaction-risk score transmitting module 226.

The transaction data receiving module 210 may be configured to receive transaction data originating from the one or more user devices 104a, 104b . . . 104n. The transaction data includes one or more data elements such as a transaction amount, a merchant identifier or merchant category code, a device identifier associated with the user device, a transaction timestamp, one or more session attributes, and application-level metadata associated with the user transaction. Upon receiving the transaction data, the transaction data receiving module 210 may be configured store the data in a temporary data structure for further processing.

The contextual feature receiving module 212 may be configured to receive the set of contextual features associated with the digital transaction from the plurality of data sources. The plurality of data sources may include device-level data streams, user interaction logs, merchant databases, location services, and network-related feeds.

In an embodiment, the temporal feature extracting module 214 may be configured to process historical activity data associated with the user and derive the set of temporal features using the transaction timestamp and contextual attributes. In an embodiment, the temporal feature extracting module 214 may be configured to extract the one or more periodic time-of-day patterns. The one or more periodic time-of-day patterns may refer to recurring behavioral sequences that appear within specific portions of a 24-hour cycle. The temporal feature extracting module 214 may be configured to determine the one or more periodic time-of-day patterns by analyzing timestamps of prior transactions or user interactions.

In an example scenario, the temporal feature extracting module 214 identifies that the user frequently performs small transactions such as mobile recharges between 8:00 AM and 9:00 AM on most weekdays. The temporal feature extracting module 214 further determines that the user rarely initiates transactions during late-night hours, such as between 1:00 AM and 4:00 AM. The one or more periodic time-of-day patterns are encoded as temporal indicators and supplied to the personalized temporal-context representation generating module 216. The one or more periodic time-of-day patterns allow the temporal feature extracting module 214 to position the current transaction within the user's typical hourly activity cycle.

The temporal feature extracting module 214 may be configured to determine the one or more weekday-weekend deviations. In an example scenario, the temporal feature extracting module 214 determines that the user consistently conducts grocery purchases on weekends and exhibits minimal purchasing activity on weekdays. The temporal feature extracting module 214 also identifies that transportation-related transactions occur predominantly on weekdays during morning or evening commute periods. These behavioral differences are encoded as weekday or weekend temporal features and passed to the personalized temporal-context representation generating module 216.

The temporal feature extracting module 214 may be configured to determine the one or more seasonality-based behavioral cycles. For example, the temporal feature extracting module 214 recognizes that the user performs large travel-related transactions every December, corresponding to recurring annual travel. The temporal feature extracting module 214 detects that periodic subscription renewals occur at the beginning of each month, forming a monthly seasonality cycle. The extracted seasonality indicators reflect long-term periodic behaviors and are incorporated into the personalized temporal-context representation. The seasonal cycles allow the system 102 to position the current transaction within long-horizon behavioral trends or recurring events.

In an embodiment, the personalized temporal-context representation generating module 216 may be configured to generate the personalized temporal-context representation of the user using a behavioral-rhythm learning model based on the received set of contextual features and the extracted set of temporal features. The behavioral-rhythm learning model may include an attention-based temporal neural network. In an embodiment, the personalized temporal-context representation generating module 216 may be configured to combine the set of contextual features and the set of temporal features into a unified behavioral representation.

In some embodiments, the personalized temporal-context representation generating module 216 employs a temporal neural network, a transformer-based model, or a hybrid sequential encoder. For example, the personalized temporal-context representation generating module 216 generates a personalized temporal-context representation characterizing the user's behavioral profile at the time of the transaction.

In an embodiment, the deviation detecting module 218 may be configured to detect a deviation between the personalized temporal-context representation and the baseline behavioral signature of the user. The deviation detecting module 218 may be configured to compare the personalized temporal-context representation of the current transaction with the baseline behavioral signature generated from the user's historical activity. The baseline behavioral signature may be updated in response to one or more authorized transactions. The baseline behavioral signature may be incrementally updated using one or more confirmed transaction outcomes such that subsequent transaction-risk scores reflect evolving user behavior patterns. In an embodiment, the deviation detecting module 218 may be configured to distinguish legitimate behavioral evolution from fraudulent activity, thereby reducing false transaction declines relative to rule-based authorization systems

In an embodiment, the deviation detecting module 218 may be configured to perform a deviation analysis identifying one or more short-term behavioral deviations, evaluating one or more long-term behavioral drifts. The deviation detecting module 218 may be configured to compare signals from the current representation with the baseline behavioral signature. The output is a deviation indicator representing the degree of alignment or misalignment between the transaction behavior and the user's historical behavioral profile.

In an embodiment, the transaction-risk score computing module 220 may be configured to compute a transaction-risk score indicative of the abnormal activity or the fraudulent activity. Further, the transaction-risk score computing module 220 may be configured to generate a numerical value using a prediction engine. The prediction engine may include a temporal neural network and a context-adaptive transformer. The numerical value may be generated based on contextual anomaly indicators derived from the received set of contextual features or one or more temporal anomaly indicators derived from the extracted set of temporal features, or a similarity measure between the personalized temporal-context representation and the baseline behavioral signature of the user.

In an embodiment, the transaction-risk score computing module 220 may be configured to use a a hybrid prediction engine to compute the transaction-risk score comprising a temporal network and a context-adaptive transformer. The hybrid prediction engine may be configured to adaptively modulate parameters based on emerging user-behavior shifts without requiring retraining of the entire model

In an example scenario, the contextual feature receiving module 210 identifies that the current transaction originates from a new mobile device not recorded in the historical device profile of the user. The system 102 assigns a contextual anomaly indicator representing a device change. The temporal feature extracting module determines that the transaction occurred at 2:45 AM, which is outside the typical activity window of the user of 8:00 AM to 10:00 PM. The temporal feature extracting module generates a temporal anomaly indicator representing an unusual time-of-day event. The personalized temporal-context representation shows low similarity to the baseline behavioral signature due to deviation in both device usage and time-of-day behavior. The prediction engine processes the anomaly indicators using the temporal neural network and context-adaptive transformer. The combined anomalies result in a numerical transaction-risk score reflecting reduced similarity to the baseline pattern.

In an example scenario, device, location, and network attributes match the user's baseline profile, producing no contextual anomaly. Temporal anomaly indicator includes historical seasonality data indicates that the user makes international travel purchases every December. The current transaction is a travel booking in May, generating a temporal anomaly indicator representing a seasonality-based deviation. The representation shows moderate similarity, aligning in contextual features but diverging in seasonal temporal patterns. The prediction engine processes the seasonal anomaly using the temporal neural network, assigning a deviation signal to the long-term temporal dimension. A corresponding transaction-risk score is produced reflecting the seasonal mismatch.

In an example scenario, the user transaction originates from an unrecognized device and an atypical geographic location. The time-of-day and weekday patterns do not match historical behavior. The personalized representation exhibits low similarity to the baseline behavioral signature in contextual, temporal, and periodic activity dimensions. Both model components (temporal neural network and context-adaptive transformer) register multiple anomaly signals. The prediction engine produces a high deviation score, resulting in a high transaction-risk score.

In an embodiment, the decision generating module 224 may be configured to generate the decision output based on the transaction-risk score and the personalized temporal-context representation. The decision output may be selected from one or more of a personalized credit-limit recommendation, an adaptive authorization rule, and a transaction-confidence indicator.

In an embodiment, the decision generating module 224 may be configured to transform raw transaction-level contextual features and historical temporal features into a unified machine-learned behavioral embedding that represents an expected transaction behavior profile for the user at a specific point in time. The personalized temporal-context representation may be generated using privacy-preserving or federated learning techniques without centralizing raw transaction data.

The decision output may include one or more of a parameter value indicating a personalized credit-limit adjustment, a rule parameter defining an adaptive authorization condition for the digital transaction, and a numerical indicator indicating a transaction-confidence level. The personalized credit-limit adjustment may include an increase or decrease relative to a baseline credit limit associated with the user or a specific transaction channel. The adaptive authorization rule may include an adaptive authorization condition for the user transaction, such as a rule type identifier and one or more condition parameters specifying whether additional authentication, step-up verification, manual review, or automatic approval is to be applied. The numerical indicator may indicate the transaction-confidence level, such as a normalized value or score representing the degree to which the transaction is determined to be consistent with the behavioral profile of the user.

The decision generating module 224 may be configured to map the transaction-risk score to one or more discrete ranges or thresholds and combine such mapping with attributes derived from the personalized temporal-context representation. For example, in some embodiments, a low transaction-risk score and a high behavioral similarity value may lead to the decision output specifying a higher transaction-confidence indicator and a less restrictive authorization rule. In another embodiment, a high transaction-risk score and a low behavioral similarity value may generate the decision output specifying a more restrictive authorization condition and a lower confidence indicator.

The transaction-risk score transmitting module 226 may be configured to transmit the transaction-risk score of the decision output for downstream authorization of the digital transaction a payment gateway. The transaction-risk score transmitting module 226 may be configured to format the data according to a predefined communication schema or Application Programming Interface (API) protocol and transmit the data to the payment gateway over one or more communication channels such as HTTPS, REST API, message queue protocol, or secure socket communication. Upon receiving the transmitted data, the payment gateway processes the risk score and the auxiliary decision output to determine an appropriate downstream authorization action. The authorization action may include automatic approval, step-up authentication, conditional authorization, temporary hold, or transaction decline, depending on the parameters contained in the decision output.

In an example scenario, the user initiates a digital purchase using the user device 104a, 104b, . . . or 104n and from a location not previously associated with historical activity. The system 102 receives transaction data and processes the set of contextual and temporal features. The prediction engine computes the transaction-risk score of 0.92 on a scale of 0 to 1, where values closer to 1 indicate a higher likelihood of abnormal behavior. The decision generating module produces the decision output, which includes a rule parameter: STEP_UP_AUTH (requiring additional verification), a credit-limit adjustment parameter: no adjustment, and a confidence indicator: 0.25.

The transaction-risk score transmitting module packages the following data in a standardized API message transaction ID: TXN-98442, transaction-risk score: 0.92, rule parameter: STEP UP AUTH, and confidence indicator: 0.35. The transaction-risk score transmitting module 226 transmits aforementioned data over a secure Hypertext Transfer Protocol Secure (HTTPS) channel to the payment gateway.

Upon receiving the data, the payment gateway interprets the STEP_UP_AUTH rule parameter and triggers additional user authentication, such as sending a one-time passcode (OTP) to the registered mobile number or requiring biometric validation. The payment gateway waits for user input. If the user successfully completes the additional authentication, the payment gateway authorizes the transaction. If not, the payment gateway declines the transaction. After the payment gateway completes downstream authorization process, the payment gateway returns an authorization result (e.g., APPROVED, DECLINED, ADDITIONAL INPUT REQUIRED), which may be logged or further processed by the cloud server 108 for behavioral-learning updates.

FIG. 3A illustrates a flowchart depicting a method 300a-300b for scoring a user transaction by monitoring contextual and temporal features, in accordance with an embodiment of the present disclosure.

Referring to FIG. 3A, at step 302, the method 300a may include receiving, from the one or more user devices 104a, 104b . . . 104n, transaction data associated with a digital transaction of the user.

At step 304, the method 300a may include receiving, from the plurality of data sources, the set of contextual features associated with the user transaction based on the received transaction data.

At step 306, the method 300a may include extracting, from the activity history of the user, the set of temporal features based on the received set of contextual features.

At step 308, the method 300a may include generating the personalized temporal-context representation of the user based on the received set of contextual features and the extracted set of temporal features.

At step 310, the method 300a may include detecting the deviation between the personalized temporal-context representation and a baseline behavioral signature of the user.

Referring to FIG. 3B, at step 312, the method 300b may include computing the transaction-risk score indicative of one or more of the abnormal activity and the fraudulent activity.

At step 314, the method 300b may include generating the decision output based on the transaction-risk score and the personalized temporal-context representation.

At step 316, the method 300b may include transmitting, to the payment gateway, the transaction-risk score of the decision output for downstream authorization of the digital transaction.

The transaction data may include the transaction amount, the merchant category, the device identifier, and the transaction timestamp.

The set of contextual features may include the one or more of device usage patterns, one or more geological consistency signals, the one or more network characteristics, and the one or more historical merchant interaction profiles.

The set of temporal features may include the one or more periodic time-of-day patterns, the one or more weekday-weekend deviations, and the one or more seasonality-based behavioral cycles.

In an embodiment, for generating the personalized temporal-context representation, the method 300a-300b may include assigning the one or more feature-specific weights to the set of contextual features and the temporal features temporal features based on the relevance to the digital transaction. Further, the method 300a-300b may include generating the personalized temporal-context representation of the user based on the assigned one or more feature-specific weights.

In an embodiment, the method 300a-300b may include assigning one or more feature-specific weights using a learned attention mechanism that dynamically emphasizes contextual or temporal features based on historical deviation impact.

In an embodiment, for detecting the deviation, the method 300a-300b may include evaluating the one or more short-term behavioral deviations in combination with the one or more long-term behavioral drifts of the user. Further, the method 300a-300b may include detecting the deviation between the personalized temporal-context representation and the baseline behavioral signature of the user based on the evaluation.

In an embodiment, for computing the transaction-risk score, the method 300a-300b may include generating, by the prediction engine comprising the temporal neural network and the context-adaptive transformer, the numerical value. The numerical value may be generated based on one or more contextual anomaly indicators derived from the received set of contextual features, one or more temporal anomaly indicators derived from the extracted set of temporal features, and a similarity measure between the personalized temporal-context representation and the baseline behavioral signature of the user.

In an embodiment, the baseline behavioral signature may include the data structure generated from historical transaction records of the user. The data structure may include one or more aggregated contextual feature profiles derived from past transactions, one or more aggregated temporal feature profiles, and one or more statistical or machine-learned parameters updated over time to reflect the prior behavioral patterns of the user.

The decision output may be selected from the personalized credit-limit recommendation, the adaptive authorization rule, and the transaction-confidence indicator. The decision output may include one or more of the parameter value indicating the personalized credit-limit adjustment, the rule parameter defining the adaptive authorization condition for the digital transaction, and the numerical indicator indicating a transaction-confidence level.

The methods may be implemented in any suitable hardware, software, firmware, or combination thereof.

Thus, various embodiments of the present invention provide several technical advantages over conventional cloud security and compliance management systems.

The present disclosure enables unified processing of contextual features and temporal behavior patterns within a single analytical framework.

The present disclosure utilizes a personalized temporal-context representation to model user-specific behavioral characteristics rather than relying solely on population-level profiles.

The present disclosure detects short-term behavioral deviations together with long-term behavioral drifts, improving precision in identifying anomalous transaction activity.

The present disclosure employs a hybrid prediction engine combining a temporal neural network and a context-adaptive transformer for multi-dimensional feature evaluation.

The present disclosure facilitates dynamic updating of baseline behavioral signatures using continuous historical transaction data.

The present disclosure generates numerical risk scores that incorporate contextual anomaly indicators, temporal anomaly indicators, and similarity measures in a structured manner.

The present disclosure supports generation of multiple types of decision outputs including credit-limit parameters, adaptive authorization rules, and confidence indicators from the same scoring pipeline.

The present disclosure provides modular processing through distinct functional components, enabling scalable and distributed deployment across cloud environments.

The present disclosure allows downstream systems such as payment gateways to receive structured decision data for real-time authorization actions.

The present disclosure improves consistency of authorization workflow by transmitting standardized risk and decision signals through defined communication interfaces.

The present disclosure enhances interpretability of transaction analysis by representing behavioral features and deviation indicators in discrete, machine-parsable forms.

The following scenarios describe practical examples of how the system 102 processes transaction data, derives contextual and temporal features, computes anomaly indicators, generates a personalized temporal-context representation, computes a transaction-risk score, and generates an auxiliary decision output. All numeric values, scores, and parameters are examples for illustration of actual system behavior.

In an example scenario, Unusual Night-Time Transaction From New Device

### Input Data

Transaction amount: $10,500
Transaction timestamp: 01:18 AM
Merchant category: Electronics (MCC 5736)
Device ID: DEV-9923
Historical device IDs: DEV-1042, DEV-1043
Location: California, while historical location radius is New York

### Extracted Features

Contextual features: new device, new location, unusual merchant category
Temporal features: timestamp outside the user's normal window (6:00 AM-10:00 PM)

### Generated Indicators

Contextual anomaly indicator=0.88
Temporal anomaly indicator=0.78
Similarity measure (representation vs baseline)=0.22

### Transaction-Risk Score Computation

The prediction engine processes the above values using the temporal neural network and transformer encoder and generates:
transaction-risk score=0.95

### Decision Output

Authorization rule: STEP_UP AUTH
Credit-limit adjustment: No change
Confidence level: 0.30

### Downstream Action

The payment gateway receives:
{txn_id: “TXN-82182, risk_score: 0.95, rule: “STEP_UP_AUTH”, confidence: 0.20}
It triggers OTP-based verification before authorizing the transaction.

### Scenario 2: Typical Grocery Purchase Matching Historical Behavior

### Input Data

Amount: [symbol] 1500
Time: 06:05 PM
Merchant: Grocery (MCC 5422)
Device: DEV-1034 (frequent)
Location: Within 2 km of usual home radius
History: ˜20 grocery purchases/month, usually between 5-7 PM

### Extracted Features

Contextual features: matched device, familiar location, known merchant
Temporal features: timestamp within known active hours

### Generated Indicators

Contextual anomaly indicator=0.07
Temporal anomaly indicator=0.04
Similarity measure=0.92

### Transaction-Risk Score

0.08 (low)

### Decision Output

Rule: AUTO_APPROVE
Credit-limit adjustment: + [symbol] 2,000 temporary buffer
Confidence indicator: 0.95

### Downstream Action

Gateway auto-approves the transaction and allows the temporary credit-limit buffer for the next 24 hours.

### Scenario 3: Seasonal Travel Pattern Consistent With History

### Input Data

Amount: $5000
Merchant: Airline (MCC 4518)
Timestamp: December 25
Historical pattern: Flight bookings every December for 3 years

### Generated Indicators

Contextual anomaly: 0.20
Temporal anomaly (seasonal): 0.10
Similarity measure: 0.89

### Transaction-Risk Score

0.14

### Decision Output

Rule: STANDARD_AUTH
Credit-limit adjustment: +$10000
Confidence: 0.89

### Downstream Action

Gateway processes normally and applies the seasonal credit bump.

### Scenario 4: Multi-Dimensional Deviations Across All Feature Sets

### Input Data

Time: 02:41 AM
Device: new
Merchant: High-value luxury
Location: Chicago, historical radius: New York
Amount: $20000, historical average: $2000

### Generated Indicators

Contextual anomaly: 0.95
Temporal anomaly: 0.89
Similarity measure: 0.08

### Transaction-Risk Score

0.98

### Decision Output

Rule: BLOCK_OR_MANUAL_REVIEW
Confidence: 0.08
Credit-limit adjustment:—$20000 immediate reduction

### Downstream Action

Gateway blocks transaction and forwards case to risk operations team.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article.

Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A method for scoring a user transaction by monitoring contextual and temporal features, the method comprising:
receiving, from one or more user devices, transaction data associated with a digital transaction of a user;
receiving, from a plurality of data sources, a set of contextual features associated with the user transaction based on the received transaction data;
extracting, from an activity history of the user, a set of temporal features based on the received set of contextual features;
generating a personalized temporal-context representation of the user based on the received set of contextual features and the extracted set of temporal features;
detecting a deviation between the personalized temporal-context representation and a baseline behavioral signature of the user;
computing a transaction-risk score indicative of one or more of an abnormal activity and a fraudulent activity;
generating a decision output based on the transaction-risk score and the personalized temporal-context representation; and
transmitting, to a payment gateway, one or more of the transaction-risk score of the decision output for downstream authorization of the digital transaction.

2. The method of claim 1, wherein the transaction data comprising a transaction amount, a merchant category, a device identifier, and a transaction timestamp.

3. The method of claim 1, wherein the set of contextual features comprises one or more of device usage patterns, one or more geological consistency signals, one or more network characteristics, and one or more historical merchant interaction profiles.

4. The method of claim 1, wherein the set of temporal features comprises one or more periodic time-of-day patterns, one or more weekday-weekend deviations, and one or more seasonality-based behavioral cycles, wherein the set of temporal features comprises pay cycle aligned periodicity, one or more holiday-specific activity markers, and one or more long-horizon behavioural seasonality indicators.

5. The method of claim 1, wherein generating the personalized temporal-context representation comprises:
assigning one or more feature-specific weights using a learned attention mechanism to the set of contextual features and the temporal features temporal features based on a relevance to the digital transaction; and
generating the personalized temporal-context representation of the user based on the assigned one or more feature-specific weights, wherein generating the personalized temporal-context representation comprises transforming raw transaction-level contextual features and historical temporal features into a unified machine-learned behavioral embedding that represents an expected transaction behavior profile for the user at a specific point in time, wherein the personalized temporal-context representation is generated using privacy-preserving or federated learning techniques without centralizing raw transaction data.

6. The method of claim 1, wherein detecting the deviation comprises:
evaluating one or more short-term behavioral deviations in combination with one or more long-term behavioral drifts of the user; and
detecting the deviation n between the personalized temporal-context representation and the baseline behavioral signature of the user based on the evaluation, wherein the baseline behavioral signature is updated in response to one or more authorized transactions, wherein the baseline behavioral signature is incrementally updated using one or more confirmed transaction outcomes such that subsequent transaction-risk scores reflect evolving user behavior patterns.

7. The method of claim 1, wherein computing the transaction-risk score comprises:
generating, by a prediction engine comprising a temporal neural network and a context-adaptive transformer, a numerical value based on one or more of:
one or more contextual anomaly indicators derived from the received set of contextual features;
one or more temporal anomaly indicators derived from the extracted set of temporal features, wherein the temporal neural network models sequential transaction dependencies and the context-adaptive transformer models cross-feature interactions between contextual and temporal signals; and
a similarity measure between the personalized temporal-context representation and the baseline behavioral signature of the user.

8. The method of claim 1, wherein the baseline behavioral signature comprises a data structure generated from historical transaction records of the user, the data structure including:
one or more aggregated contextual feature profiles derived from past transactions; and
one or more aggregated temporal feature profiles; and one or more statistical or machine-learned parameters updated over time to reflect the prior behavioral patterns of the user.

9. The method of claim 1, wherein the decision output is selected from one or more of a personalized credit-limit recommendation, an adaptive authorization rule, and a transaction-confidence indicator, wherein the decision output comprises a temporary transaction specific credit-limit adjustment derived from a confidence level associated with the personalized temporal-context representation.

10. The method of claim 1, wherein the decision output comprises one or more of a parameter value indicating a personalized credit-limit adjustment, a rule parameter defining an adaptive authorization condition for the digital transaction, and a numerical indicator indicating a transaction-confidence level.

11. A system for scoring a user transaction by monitoring contextual and temporal features, the system comprising:
a memory;
at least one processor operatively coupled to the memory, wherein the at least one processor is configured to:
receive, from one or more user devices, transaction data associated with a digital transaction of a user;
receive, from a plurality of data sources, a set of contextual features associated with the user transaction based on the received transaction data;
extract, from an activity history of the user, a set of temporal features based on the received set of contextual features;
generate a personalized temporal-context representation of the user based on the received set of contextual features and the extracted set of temporal features;
detect a deviation between the personalized temporal-context representation and a baseline behavioral signature of the user;
compute a transaction-risk score indicative of one or more of an abnormal activity and a fraudulent activity;
generate a decision output based on the transaction-risk score and the personalized temporal-context representation; and
transmit, to a payment gateway, one or more of the transaction-risk score of the decision output for downstream authorization of the digital transaction.

12. The system of claim 11, wherein the transaction data comprises a transaction amount, a merchant category, a device identifier, and a transaction timestamp.

13. The system of claim 11, wherein the set of contextual features comprises one or more of device usage patterns, one or more geological consistency signals, one or more network characteristics, and one or more historical merchant interaction profiles.

14. The system of claim 11, wherein the set of temporal features comprises one or more periodic time-of-day patterns, one or more weekday-weekend deviations, and one or more seasonality-based behavioral cycles, wherein the set of temporal features comprises pay cycle aligned periodicity, one or more holiday-specific activity markers, and one or more long-horizon behavioural seasonality indicators.

15. The system of claim 11, wherein to generate a personalized temporal-context representation, the at least one processor is configured:
assign one or more feature-specific weights to the set of contextual features and the temporal features temporal features based on a relevance to the digital transaction; and
generate a personalized temporal-context representation of the user based on the assigned one or more feature-specific weights, wherein generating the personalized temporal-context representation comprises transforming raw transaction-level contextual features and historical temporal features into a unified machine-learned behavioral embedding that represents an expected transaction behavior profile for the user at a specific point in time, wherein the personalized temporal-context representation is generated using privacy-preserving or federated learning techniques without centralizing raw transaction data.

16. The system of claim 11, wherein to detect the deviation, the at least one processor is configured:
evaluate one or more short-term behavioral deviations in combination with one or more long-term behavioral drifts of the user; and
detect the deviation between the personalized temporal-context representation and the baseline behavioral signature of the user based on the evaluation.

17. The system of claim 11, wherein to compute the transaction-risk score, the at least one processor is configured:
generate, by a prediction engine comprising a temporal neural network and a context-adaptive transformer, a numerical value based on:
one or more contextual anomaly indicators derived from the received set of contextual features;
one or more temporal anomaly indicators derived from the extracted set of temporal features; and
a similarity measure between the personalized temporal-context representation and the baseline behavioral signature of the user.

18. The system of claim 11, wherein the decision output is selected from one or more of a personalized credit-limit recommendation, an adaptive authorization rule, and a transaction-confidence indicator.

19. The system of claim 11, wherein the decision output comprises one or more of a parameter value indicating a personalized credit-limit adjustment, a rule parameter defining an adaptive authorization condition for the digital transaction, and a numerical indicator indicating a transaction-confidence level.

20. A non-transitory computer-readable medium storing instructions that, when executed, cause a processor to:
receive, from one or more user devices, transaction data associated with a digital transaction of a user;
receive, from a plurality of data sources, a set of contextual features associated with the user transaction based on the received transaction data;
extract, from an activity history of the user, a set of temporal features based on the received set of contextual features;
generate a personalized temporal-context representation of the user based on the received set of contextual features and the extracted set of temporal features;
detect a deviation between the personalized temporal-context representation and a baseline behavioral signature of the user;
compute a transaction-risk score indicative of one or more of an abnormal activity and a fraudulent activity;
generate a decision output based on the transaction-risk score and the personalized temporal-context representation; and
transmit, to a payment gateway, one or more of the transaction-risk score of the decision output for downstream authorization of the digital transaction.
